(19) United States
(12) Patent Application Publication
(10) Pub. No.: US 2014/0380409 A1
(43) Pub. Date: Dec. 25, 2014

(54) NETWORK DEVICE MANAGEMENT APPARATUS, NETWORK DEVICE MANAGEMENT METHOD, AND PROGRAM FOR EXECUTING NETWORK DEVICE MANAGEMENT METHOD

(71) Applicant: CANON KABUSHIKI KAISHA, Tokyo (JP)

(72) Inventor: Toshio Ohashi, Chigasaki-shi (JP)

(21) Appl. No.: 14/307,839

(22) Filed: Jun. 18, 2014

(30) Foreign Application Priority Data
Jun. 21, 2013 (JP) 2013-131046

(51) Int. Cl. H04L 29/06

(52) U.S. Cl. CPC H04L 63/20
USPC 726/1

(57) ABSTRACT

This network device management apparatus includes an acquisition unit that acquires management information that shows a management condition of network device; a decision-making unit that decides a security policy based on management information; and a delivery unit that delivers a security policy to network device that is compatible with security policy settings.

### BACKGROUND OF THE INVENTION

1. Field of the Invention

The present invention relates to a network device management apparatus, method, and program.

2. Description of the Related Art

In recent years, with respect to functions of network device such as image forming devices, security functions have been emphasized, and have grown in diversity. To counter security threats, there exists network device that is compatible with settings of security policies configured from security rules. Thus, technology has been developed which dynamically modifies network device settings when a network device status conforms to a desired security policy (e.g., see Japanese Patent Application Laid-Open No. 2011-34561).

However, as regards the method of Japanese Patent Application Laid-Open No. 2011-34561, with respect to network device compatible with security policy settings, it has been difficult to dynamically change the security policy according to a management lifecycle or management conditions of the equipment.

### SUMMARY OF THE INVENTION

The present invention provides a network device management apparatus that can dynamically modify a security policy according to a management lifecycle or management conditions with respect to network device that is compatible with security policy settings.

The network device management apparatus according to the present invention includes an acquisition unit that acquires management information indicating a management status of network device, a decision-making unit that decides a security policy based on management information, and a delivery unit that delivers a security policy to network device compatible with security policy settings.

According to the present invention, with respect to network device compatible with security policy settings, it is possible to provide a network device management apparatus that can dynamically modify a security policy according to a management lifecycle or management conditions.

Further features of the present invention will become apparent from the following description of exemplary embodiments with reference to the attached drawings.

### BRIEF DESCRIPTION OF THE DRAWINGS

FIG. 1 is a schematic diagram illustrating a system configuration and a hardware configuration.

FIG. 2 is a schematic diagram illustrating a software configuration.

FIG. 3A is a schematic diagram illustrating a database configuration.

FIG. 3B is a schematic diagram illustrating a database configuration.

FIG. 3C is a schematic diagram illustrating a database configuration.

FIG. 4 is a flowchart of a server according to a first embodiment.

FIG. 5 is a flowchart of a server according to a second embodiment.

FIG. 6 is a flowchart of a server according to a third embodiment.

FIG. 7 is a flowchart of a server according to a fourth embodiment.

FIG. 8 is a diagram illustrating an example of a computer screen according to the fourth embodiment.

### DESCRIPTION OF THE EMBODIMENTS

Hereinafter, preferred embodiments of the present invention will be described with reference to the drawings.

### First Embodiment

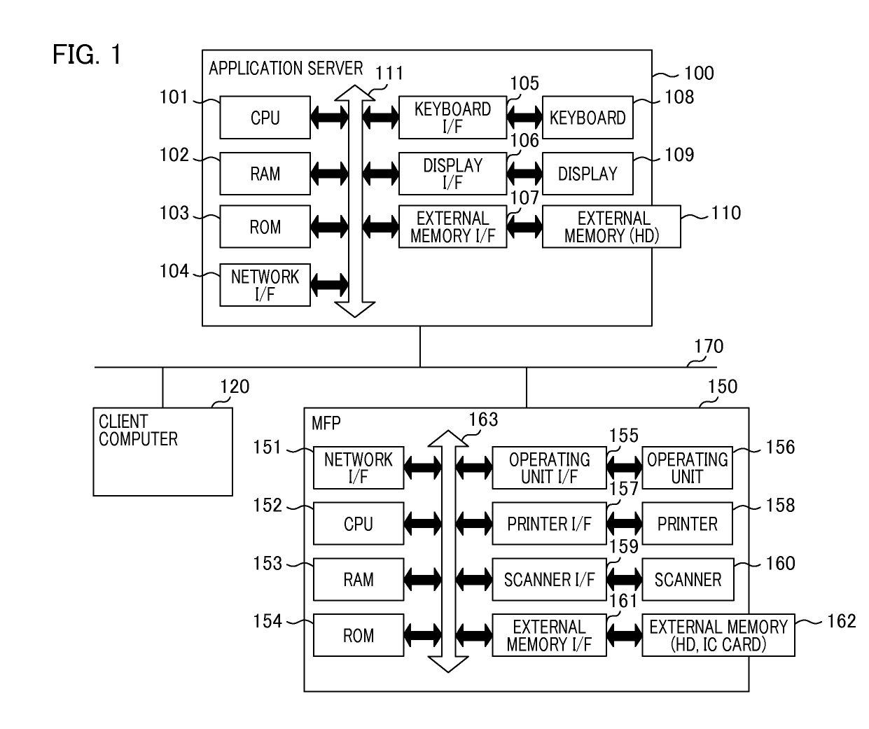

A first embodiment of the present invention is described below. First, a description is given of an application server as an example of the network device management apparatus of the present invention. As an example of network device, an MFP (multifunction peripheral) or multifunction machine is used to describe the present embodiment. Network device may also include equipment other than MFPs such as a printer or fax. FIG. 1 is a block diagram illustrating a system configuration and hardware configuration according to a network device management system including the network device management apparatus of the present embodiment.

The network device management system comprises an application server 100 connected by a network 170, a client computer 120, and an MFP 150. The application server 100 and the client computer 120 may be, for example, general-purpose computers (information processors) such as PCs. In the present embodiment, the hardware configuration of the client computer 120 is identical to that of the application server 100, and description thereof is omitted.

In the application server 100, a CPU 101 executes processing based on an application program or the like stored in a ROM 103 or an external memory 110. The CPU 101 comprehensively controls the various devices connected to a system bus 111. Furthermore, the CPU 101 opens various registered windows based on commands instructed by a mouse cursor or the like (not shown) on a display 109, and executes a variety of data processing. A RAM 102 functions as a main memory or work area of the CPU 101.

The ROM 103 is a read-only memory that functions as a storage region for basic I/O programs and the like. The ROM 103 or the below-described external memory 110 stores an operating system (hereinafter “OS”) or the like that is a control program of the CPU 101. The ROM 103 or the external memory 110 also stores files and various other data used during processing based on the aforementioned application program.

A network I/F 104 connects to the network 170, and conducts network communications. A keyboard I/F 105 controls input from a keyboard 108 or a pointing device (not shown). A display I/F 106 controls display of a display 109. An external memory I/F 107 controls access to an external memory 110 such as a hard disk (HD). The external memory 110 stores boot programs, various applications, user files, edited files, and the like.

The application server 100 operates in a condition where the CPU 101 is running a basic I/O program and an OS written into the ROM 103 or the external memory 110. The basic I/O program is written into the ROM 103, and the OS is written into the ROM 103 or the external memory 110. When the computer power supply is turned on, the OS is written into the RAM 102 from the ROM 103 or the external memory 110 by an initial program loading function in the basic I/O program, and OS operation begins. The system bus 111 is connected to various devices.

In the MFP 150, a network I/F 151 connects to the network 170, and conducts network communications. A CPU 152 outputs image signals as output information to a printer 158 via a printer I/F 157 that is connected to a system bus 163 based on a control program or the like. The control program is stored in a ROM 154 or an external memory 162 or the like. The CPU 152 is configured to be capable of conducting communication processing with a device such as a computer via the network I/F 151, and notifying the application server 100 of information or the like in the MFP 150. Furthermore, the CPU 152 executes processing based on an application program or the like stored in the ROM 154 or the external memory 162. A RAM 153 functions as a main memory or work area or the like of the CPU 152, and is configured to enable expansion of memory capacity by optional RAMs that are connected to expansion ports that are not illustrated in the drawing. The RAM 153 uses an output information development region, an environmental data storage region, a NVRAM, and the like.

The ROM 154 or the external memory 162 of a hard disk (HD) or the like stores control programs and application programs of the CPU 152, and font data used when generating the aforementioned output information, as well as information utilized by the MFP 150. Moreover, applications are temporarily stored in the ROM 154 or the external memory 162 during application installation of the MFP 150. The operating unit I/F 155 controls interface with an operating unit 156, and outputs image data to be displayed to the operating unit 156. In addition, the operating unit I/F 155 can also receive information input by a user via the operating unit 156.

The operating unit 156 is an operating panel or the like in which switches and LED displays or the like are arranged for purposes of operation. A printer I/F 157 outputs image signals as output information to a printer (printer engine) 158. A scanner I/F 159 receives image signals as input information from a scanner (scanner engine) 160. An external memory I/F (memory controller) 161 controls access to an external memory 162 such as a hard disk (HD), an IC card, or the like. The aforementioned external memory is not limited to one unit, and is provided with at least more than one unit, and may be configured to enable multiple connection of optional font cards in addition to built-in fonts, and external memories that store programs that interpret printer control languages of different language systems. Furthermore, the external memory may also have an NVRAM (not shown) and store printer mode setting information from the operating unit 156. A system bus 163 connects various devices.

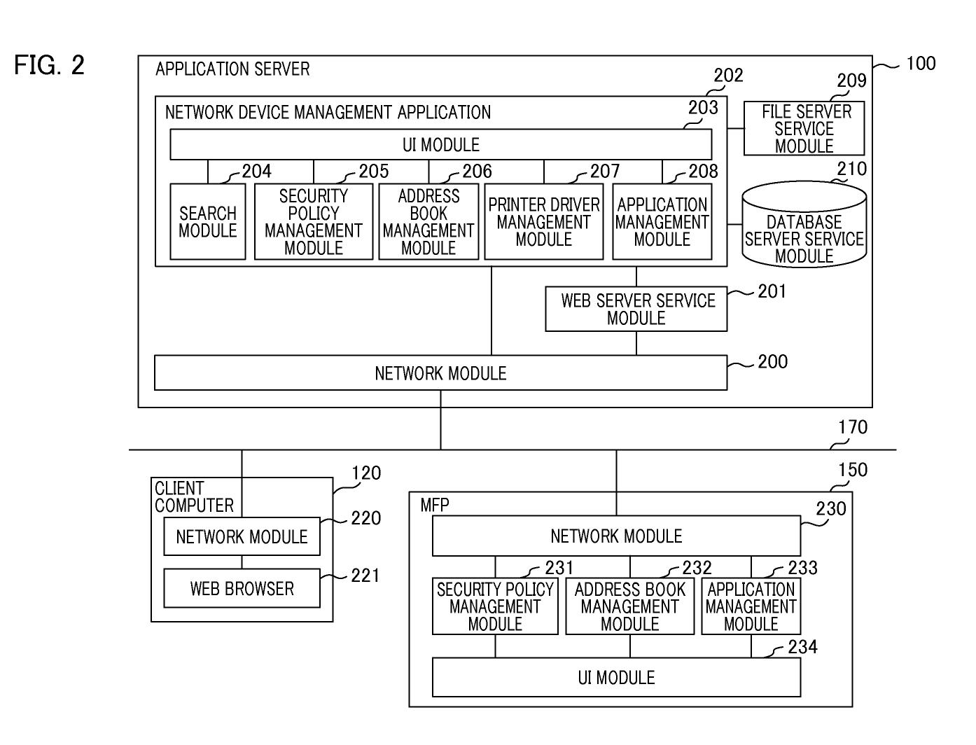

FIG. 2 is a block diagram illustrating a software configuration of a network device management system including the network device management apparatus of the present embodiment.

First, a software configuration of the application server 100 is shown. In the application server 100, a network device management application 202 and various modules exist as files that are saved in the external memory 110. These are program modules which are loaded for execution into the RAM 102 by the OS or a module utilizing that module at the time of execution. The network device management application 202 can be added to an HD of the external memory 110 through a CD-ROM (not shown) of the external memory 110, or through the network 170. The network module 200 uses a desired communication protocol, and conducts network communications with the client computer 120 and the MFP 150. Upon receiving an HTTP request from a web browser 221 of the client computer 120, a web server service module 201 replies with an HTTP response. As an example of an HTTP response of a reply, webpage data that is saved in the external memory 110 may be returned. Or a UI module 203 of the network device management application 202 may be requested to produce an HTTP response.

The network device management application 202 is an application that manages the MFP 150 connected by the application server 100 and the network 170. The network device management application 202 may be implemented as a program that executes processing in response to a request to a webpage provided by the web server service module 201. As described the above, the network device management application 202 constitutes a web application that manages the MFP 150 together with the Web server service module 201. In the network device management application 202, the UI module 203 generates an HTTP response in response to a request from the web server service module 201. The UI module 203 also receives user input information transmitted from the web browser 221 of the client computer 120, and evokes the respective modules as necessary. As examples of modules that are invoked from the UI module 203, there is a search module 204, a security policy management module 205, an address book management module 206, a printer driver management module 207, and an application management module 208. However, one is not limited thereto, and the UI module 203 may be configured to invoke modules apart from these.

The search module 204 searches the MFP 150 connected by the application server 100 and the network 170 using a desired communication protocol. As an example of a communication protocol used by the search module 204 to conduct searches, one may cite SNMP (Simple Network Management Protocol), SLP (Service Location Protocol), or the like. In addition, the search module 204 may use a communication protocol such as WS-Discovery (Web Services Dynamic Discovery). The search module 204 searches the MFP 150, and then the search module 204 acquires device information from the MFP 150 and stores it in a network device management table 300 of a below-described database server service module 210.

The security policy management module 205 acquires security policy setting information from the MFP 150. The security policy management module 205 also delivers security policy setting information to the MFP 150. Here, security policy setting information indicates setting items related to security of the MFP 150. For example, setting items are a port open setting, a mandatory firewall setting, and an initial password change enforcement setting, but one is not limited thereto, and other setting items are also acceptable.

The address book management module 206 acquires address book information of the MFP 150. The address book information is information containing addresses such as email addresses and fax numbers registered in the MFP 150. Then, the acquired address book information is then stored in an address management table 301, an address-address book management table 302, and an address book management table 303. The printer driver management module 207 installs printer drivers associated with the MFP 150 in the client computer 120. The printer driver management module 207 installs the printer drivers, and then the installation results are stored in a printer driver installation history management table 308 of the below-described database server service module 210.

The application management module 208 installs applications in the MFP 150. The application management module 208 executes installation processing of applications to the MFP 150 as task processing of a designated date and time for execution. In addition, the application management module 208 acquires task information from the application management table 304 and the application installation task management table 305 of the below-described database server service module 210. Then, the application management module 208 acquires an application stored in a below-described file server service module 209 based on task information, and installs it in the MFP 150.

The file server service module 209 manages files, and conducts storage and extraction of files in conjunction with requests from other modules. If the file server service module 209 is accessible from the network device management application 202, the file server service module 209 may be on a device that is separate from the application server 100. The file server service module 209 also may use a protocol such as an FTP (File Transfer Protocol) or a WebDAV (Web-based Distributed Authoring and Versioning) for transmission and receipt of files via the network 170.

The database server service module 210 manages data, and conducts data storage and extraction in conjunction with requests from other modules. If the database server service module 210 is accessible from the network device management application 202, database server service module 210 may be on a device that is separate from the application server 100.

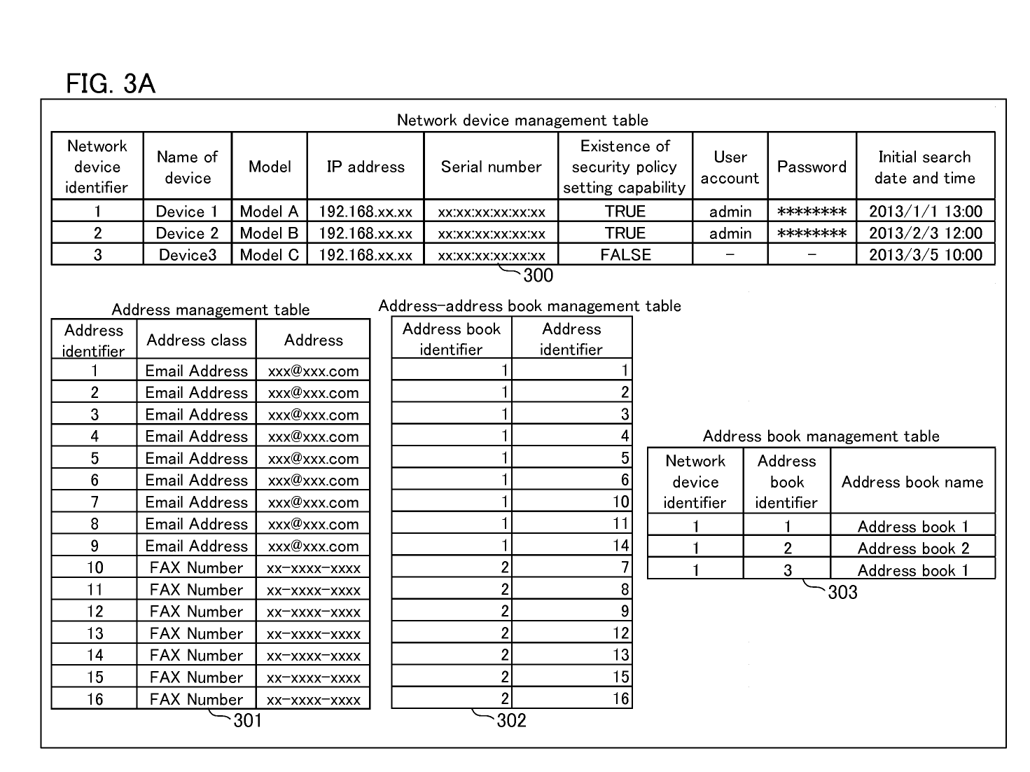

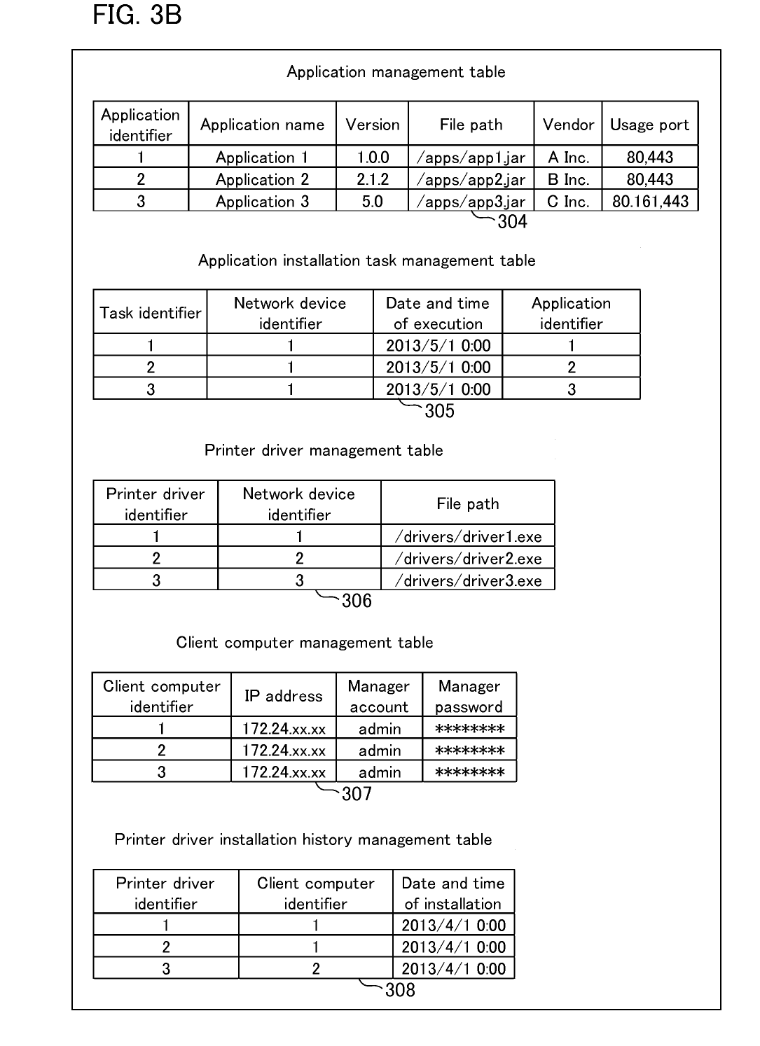

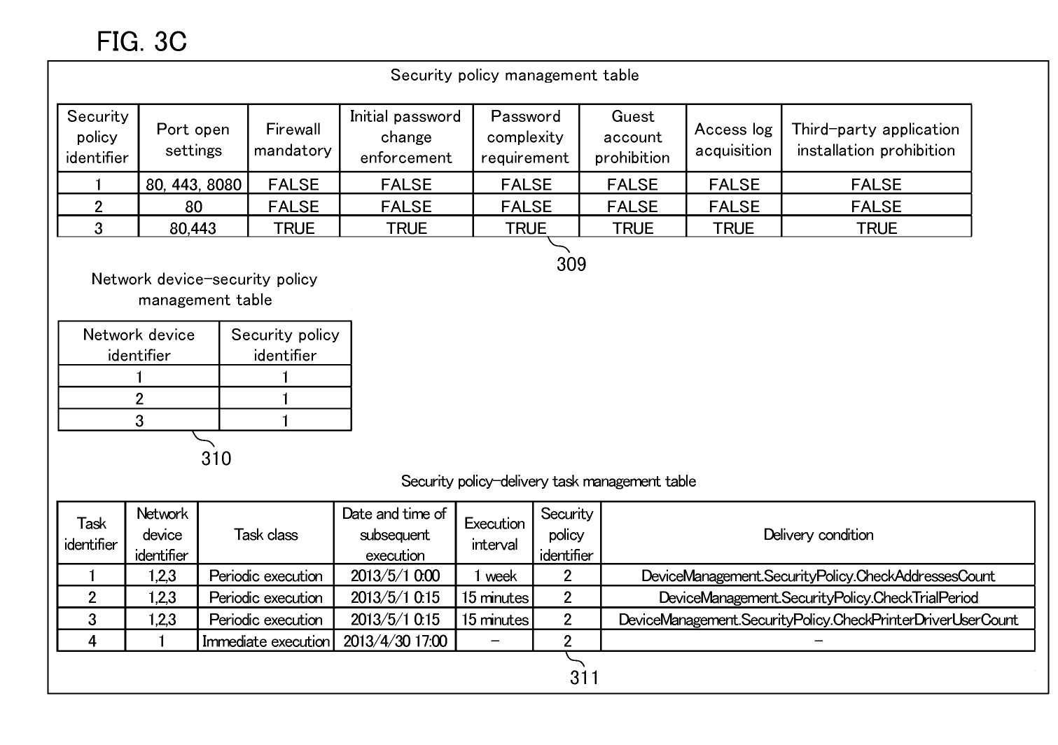

Examples of the tables in the database server service module 210 are shown FIGS. 3A to 3C. The tables shown in FIGS. 3A to 3C are only examples, and tables may have the configurations different from that of the present embodiment. First, with reference to FIG. 3A, the network device management table 300 is a table that manages information relating to the MFP 150 that is managed by the network device management application 202. The information managed by the network device management table 300 may, for example, be network device identifiers, device names, models, IP addresses, serial numbers, existence of a security policy setting capability, user accounts, passwords, initial search dates and times, and the like. The network device identifier is an identifier that uniquely identifies the MFP 150. The existence of a security policy setting capability is information which expresses whether or not the MFP 150 is compatible with a security policy that is acquired and set from the security policy management module 205 of the network device management application 202. The initial search date and time is information about a date and time on which the search module 204 of the network device management application 202 initially searches the MFP 150.

The address management table 301 is a table which manages addresses contained in an address book acquired from the MFP 150 by the address book management module 206. Information managed by the address management table 301 may be, for example, address identifiers, address categories, addresses, and the like. The address identifier is an identifier that uniquely identifies an address, and the address category is information that indicates a type of address such as an email address or a fax number.

The address-address book management table 302 is a table which manages the relation between addresses and the address book obtained from the MFP 150 by the address book management module 206. Information managed by the address-address book management table 302 may be, for example, address book identifiers, address identifiers, and the like. The address book identifier is an identifier that uniquely identifies an address book.

The address book management table 303 is a table which manages an address book acquired from the MFP 150 by the address book management module 206. The information managed by the address book management table 303 may be, for example, network device identifiers, address book identifiers, address book names, and the like.

Next, with reference to FIG. 3B, the application management table 304 is a table which manages the information of applications installed in the MFP 150 by the application management module 208. The information managed by the application management table 304 may be, for example, application identifiers, application names, versions, file paths, vendors, usage ports, and the like. The application identifier is an identifier that uniquely identifies an application, and the file path is information that indicates a path on the file server service module 209 where a file body of an application is stored. The vendor is information about a development vendor of an application, and the usage port is information about a port used by an application.

The application installation task management table 305 is a table which manages information of a task that installs an application in the MFP 150 by the application management module 208. Information managed by the application installation task management table 305 may be, for example, task identifiers, network device identifiers, dates and times for execution, application identifiers, and the like. The task identifier is an identifier that uniquely identifies a task.

The printer driver management table 306 is a table which manages printer drivers associated with the MFP 150 managed by the network device management application 202. Information managed by the printer driver management table 306 may be, for example, printer driver identifiers, network device identifiers, file paths, and the like. The printer driver identifier is an identifier that uniquely identifies a printer driver, and the file path is information that indicates a path on a file server service module 209 where a file body of a printer driver is stored.

The client computer management table 307 is a table which manages information of the client computer 120 that is the installation target of printer drivers associated with the MFP 150 managed by the network device management application 202. Information managed by the client computer management table 307 may be, for example, client computer identifiers, IP addresses, manager accounts, manager passwords, and the like. The client computer identifier is an identifier that uniquely identifies the client computer 120, and the IP address is an IP address of the client computer 120. The manager account and the manager password are manager information required for installing printer drivers into the client computer 120.

The printer driver installation history management table 308 is a table which manages installation history information when the network device management application 202 has installed printer drivers into the client computer 120. Information managed by the printer driver installation history management table 308 may be, for example, printer identifiers, client computer identifiers, dates and times of installation, and the like.

Next, with reference to FIG. 3C, the security policy management table 309 is a table which manages a security policy acquired from the MFP 150 or a security policy delivered to the MFP 150 by the security policy management module 205. Information managed by the security policy management table 309 may be, for example, security policy identifiers, port open settings, mandatory firewall settings, initial password change enforcement settings, and the like. Also, information managed by the security policy management table 309 may include other security-related settings such as password complexity requirement settings, guest account prohibition settings, access log acquisition settings, and third-party application installation prohibition settings. The security policy identifier is an identifier that uniquely identifies a security policy.

A network device-security policy management table 310 is a table which manages security policy settings acquired from the MFP 150 by the security policy management module 205. Information managed by the network device-security policy management table 310 may be, for example, network device identifiers, security policy identifiers, and the like.

The security policy delivery task management table 311 is a table which manages task information for delivery of a security policy to the MFP 150 by the security policy management module 205. Information managed by the security policy delivery task management table 311 may be, for example, task identifiers, network device identifiers, task categories, dates and times for subsequent execution, execution intervals, security policy identifiers, delivery conditions, and the like. The task category is information indicating the category of a task such as immediate execution or periodic execution, and the date and time for subsequent execution indicates a scheduled date and time for a task to be subsequently executed. The execution interval is information indicating the interval at which tasks are to be executed. The delivery condition is information indicating a condition for determining whether or not a security policy is to be delivered when a task is executed.

In FIGS. 3A to 3C, module/class/method names that implement condition logic are implemented, and other content such as script description maybe provided with information indicating a condition for determining whether or not a security policy is to be delivered.

Next, a software configuration of the client computer 120 is shown. Each module configuring the client computer 120 is a program module that respectively exists as a file saved in the ROM 103 or the external memory 110. Then the each module is loaded for execution into the RAM 102 by the OS or a module utilizing the pertinent module at the time of execution.

A network module 220 conducts network communications with the application server 100 and the MFP 150 using an arbitrary communication protocol. The web browser 221 transmits HTTP request messages via the network module 220, and receives HTTP response messages, and displays them. Access to the application server 100 from the client computer 120 is conducted through the web browser 221.

Next, a software configuration of the MFP 150 is shown. In the MFP 150, the various modules exist as file saved in the ROM 154 of the external memory 162, and are loaded for execution into the RAM 153 at the time of execution. A network module 230 conducts network communications with the application server 100 and the client computer 120 using an arbitrary communication protocol.

A security policy management module 231 conducts management of security policy settings of the MFP 150. The security policy management module 231 receives security policy settings delivered from the security policy management module 205 of the network device management application 202 via the network module 230, and reflects the setting contents.

The address book management module 232 conducts management of the address book of the MFP 150. The address book management module 232 receives an address book acquisition request from the address book management module 206 of the network device management application 202 via the network module 230, and returns address book information.

An application management module 233 conducts management of applications that are installed in the MFP 150, as well as installation processing. The application management module 233 receives an installation request transmitted from the application management module 208 of the network device management application 202 via the network module 230, and installs the application. A UI module 234 receives UI drawings displayed in the operating unit 156 of the MFP 150, and user input values that are input by UI manipulations of a user in the user section 156.

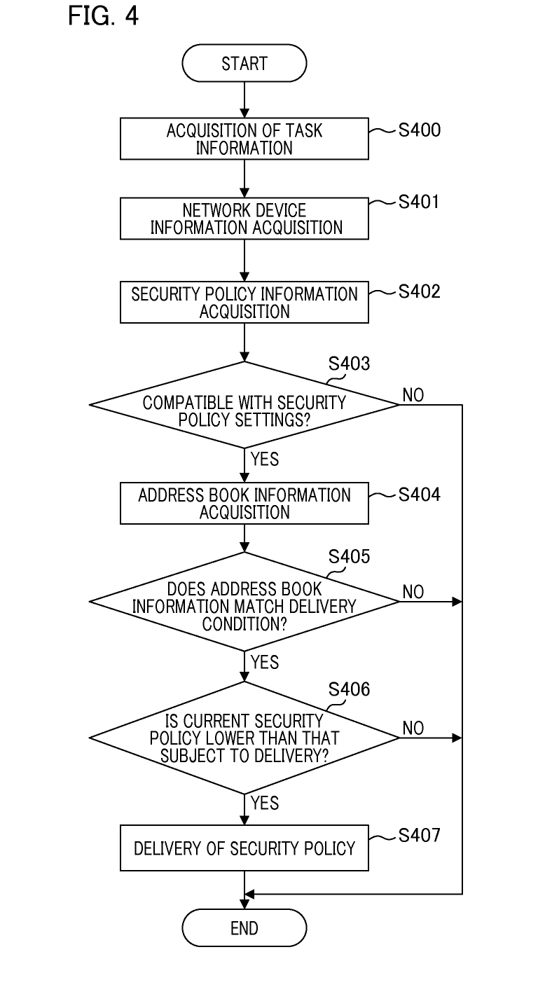

Using FIG. 4, a description is given below of operations of the application server 100 when the application server 100 dynamically delivers a security policy in response to management conditions of the MFP 150. In the present embodiment, with respect to the management conditions of the MFP 150, management conditions of an address book retained in the MFP 150 are exemplified in the description.

First, in step S400, the security policy management module 205 of the network device management application 202 acquires task information from the security policy delivery task management table 311 of the database server service module 210.

Next, in step S401, the security policy management module 205 acquires network device information from the network device management table 300 of the database server service module 210.

Next, in step S402, the security policy management module 205 acquires security policy information. At this time, it acquires the information from the security policy management table 309 and the network device-security policy management table 310 of the database server service module 210.

In step S403, the security policy management module 205 then determines whether or not the MFP 150 designated by the task is compatible with the security policy settings based on the acquired task information and network device information. When it is determined that the MFP 150 is compatible with the security policy settings (YES), the processing proceeds to step S404, and when it is determined to be incompatible (NO), processing terminates as is.

Next, in step S404, the address book management module 206 of the network device management application 202 acquires address book information. At this time, the address book management module 206 acquires the information from the address management table 301, the address-address book management table 302, and the address book management table 303 of the database server service module 210.

In step S405, the security policy management module 205 determines whether or not the acquired address book information meets the task delivery conditions. As a method for determining whether the address book information meets the task delivery conditions, for example, it is determined whether the number of addresses exceeds an arbitrary threshold, or whether important addresses with a high security risk are included. However, one is not limited to these methods, and the determination may also be conducted by other determination methods. When the address book information meets the task delivery conditions (YES), the processing proceeds to step S406, and when it does not meet the conditions (NO), the processing terminates as is.

Next, in step S406, the security policy management module 205 determines whether the security of the current security policy settings of the MFP 150 is lower than that of the security policy subject to delivery. Here, a security policy subject to delivery is an optimal security policy decided according to the aforementioned management information acquired in advance (network device information, security policy information, and the like). When it is determined that the security is low (YES), the processing proceeds to step S407, and in the case where it is determined that the security is not low (NO), the processing is terminated as is. In step S407, the security policy management module 205 then delivers the security policy designated by the task to the MFP 150. Then, The processing is terminated.

According to the above processing, a security policy can be dynamically changed in response to management conditions of an address book with respect to an MFP 150 that is compatible with the security policy settings. As a result, it is possible to conduct an operation that enhances a security policy of an MFP 150 that holds many addresses. In the present embodiment, an address book was exemplified in the description as an example of setting information, but it is otherwise also acceptable to use history information such as an error history of the MFP 150.

From the foregoing, according to the present embodiment, with respect to network device compatible with security policy settings, it is possible to provide a network device management apparatus that can dynamically change a security policy according to a management lifecycle or management conditions.

### Second Embodiment

In the first embodiment, a description was given of a method for dynamically changing a security policy according to setting information of the MFP 150, but in the present embodiment, a description is given of a method that also dynamically changes a security policy according to the passage of time from the start of management of the MFP 150. As the system configuration, hardware configuration, and software configuration of the client server system are identical to FIG. 1, FIG. 2, and FIGS. 3A to 3C of the first embodiment, description thereof is omitted.

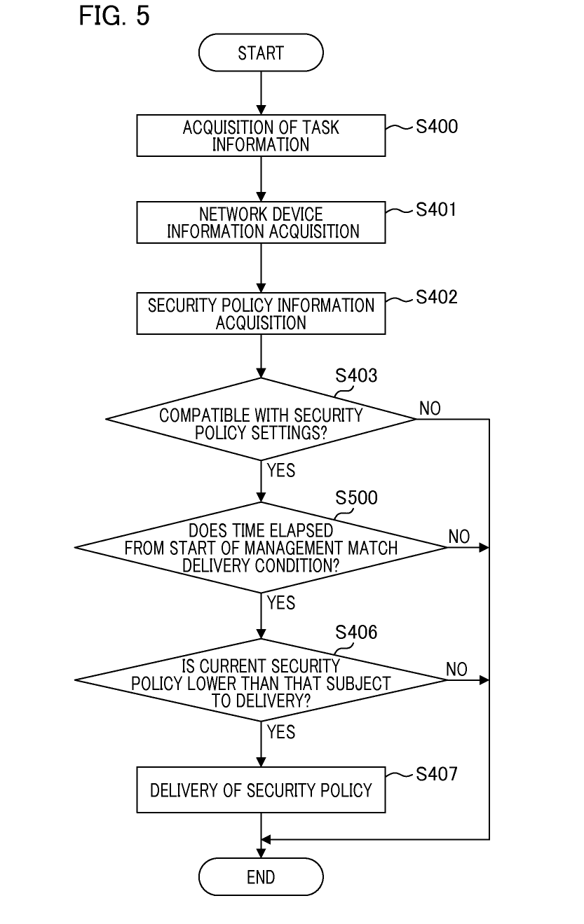

Using FIG. 5, a description is given below of operations of the application server 100 when the application server 100 dynamically delivers a security policy according to a time elapsed from the start of management of the MFP 150. As steps S400 to S403 and steps S406 to S407 are the same steps as FIG. 4 of the first embodiment, description thereof is omitted. In the present embodiment, only those portions that differ from the first embodiment are described.

When it is determined in step S403 that the security policy management module 205 is compatible with the security policy settings of the MFP 150 (YES), the processing proceeds to step S500. In step S500, the security policy management module 205 then determines whether or not the time elapsed from the start of management of the MFP 150 meets the delivery condition based on the acquired network device information. Time elapsed from start of management of the MFP 150 is calculated based on the current time and the initial search date and time included in the acquired network device information. With respect to determining whether a time elapsed from start of management of the MFP 150 meets the delivery condition, for example, it is determined whether time has elapsed beyond an arbitrary threshold. When a time elapsed from start of management of the MFP 150 meets the delivery condition (YES), the processing proceeds to step S406, and when it does not meet the condition (NO), the processing is terminated as is.

According to the above processing, a security policy can be dynamically changed according to a time elapsed from start of management with respect to an MFP 150 compatible with security policy settings. As a result, it is possible, for example, to conduct an operation that enhances a security policy level when the installation and initial introduction phase of an MFP 150 has been completed. In the present embodiment, time elapsed from start of management of the MFP 150 was exemplified in the description, but it is also acceptable to calculate a scheduled time until management termination of the MFP 150 based on information such as, for example, a lease termination date, or a planned scrapping date, and use the computation result for purposes of determination.

### Third Embodiment

In the first embodiment, a description was given of a method for dynamically changing a security policy according to setting information of the MFP 150. In the second embodiment, a description was given of a method for dynamically changing a security policy according to time elapsed from start of management of the MFP 150. In the present embodiment, a description is also given of a method for dynamically changing a security policy according to information of a user who uses the MFP 150. In the present embodiment, printer driver installation information is used as the user information. As the system configuration, hardware configuration, and software configuration of the client server system of the present embodiment are identical to FIG. 1, FIG. 2, and FIGS. 3A to 3C of the first embodiment, description thereof is omitted.

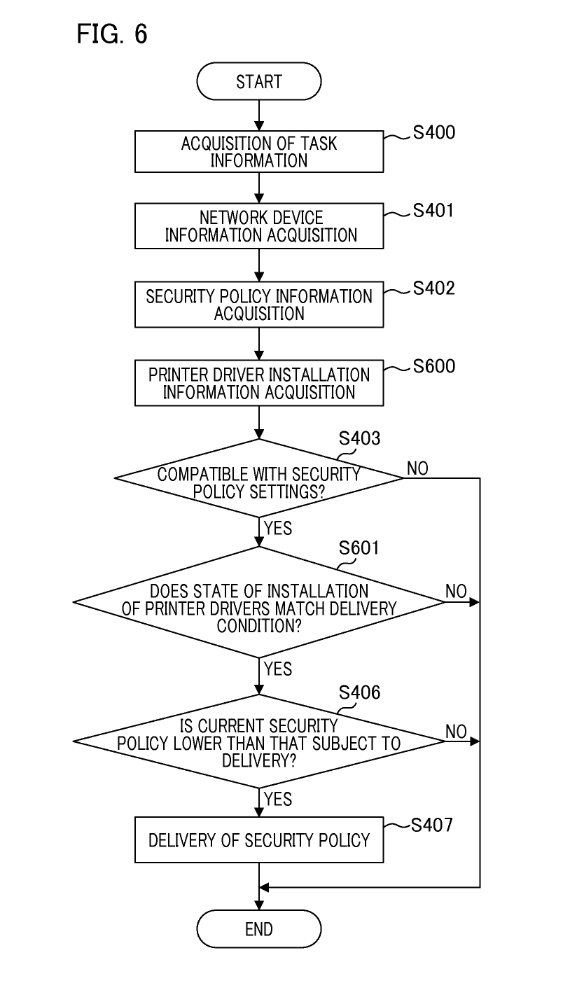

Using FIG. 6, a description is given below of operations of the application server 100 when the application server 100 dynamically delivers a security policy according to management conditions of the MFP 150. As steps S400 to S403 and steps S406 to S407 are identical to the steps of FIG. 4 of the first embodiment, description thereof is omitted. In the present embodiment, only portions that differ from the first embodiment are described.

When the security policy management module 205 acquires the security policy information in step S402, the processing advances to step S600. In step S600, the printer driver management module 207 of the network device management application 202 acquires printer driver installation information from a table of the database server service module 210. The printer driver installation information is acquired from the printer driver management table 306, the client computer management table 307, and the printer driver installation history management table 308 of the database server service module 210. When acquisition of the printer driver installation information is completed, the processing advances to step S403.

When the security policy management module 205 determines in step S403 that the MFP 150 is compatible with the security policy settings (YES), the processing proceeds to step S601. In step S601, the security policy management module 205 determines whether a printer driver installation condition meets a delivery condition based on the acquired printer driver installation information. Determination of whether the printer driver installation condition meets the delivery condition is conducted, for example, by determining whether the printer drivers have been installed in a quantity that is at or above an arbitrary threshold. Otherwise, for example, it is also acceptable to determine whether the printer drivers are being installed to an important client computer with a high security risk. When the printer driver installation condition meets the delivery condition (YES), the processing proceeds to step S406, and when it does not meet the condition (NO), the processing is terminated as is.

According to the above processing, a security policy can be dynamically changed according to information of a user who uses the MFP 150. As a result, for example, when the printer drivers have been installed to a fixed quantity or above, it is possible to conduct an operation that raises the security policy level, because there would be a major impact if security troubles were to arise. In the present embodiment, printer driver installation information is used as the information of the user of the MFP 150, but it is otherwise also acceptable, for example, to use information concerning user accounts capable of log-in to the MFP 150, and the like.

### Fourth Embodiment

In the first embodiment, a description was given of a method for dynamically changing a security policy according to setting information of the MFP 150. In the second embodiment, a description was given of a method for dynamically changing a security policy according to time elapsed from start of management of the MFP 150. In the third embodiment, a method was shown for dynamically changing a security policy according to information of a user who uses the MFP 150. In the present embodiment, a description is also given of a method for dynamically changing a security policy according to preparation conditions of a task that manages the MFP 150.

As the system configuration, hardware configuration, and software configuration of the client server system of the present embodiment are identical to FIG. 1, FIG. 2, and FIGS. 3A to 3C of the first embodiment, description thereof is omitted.

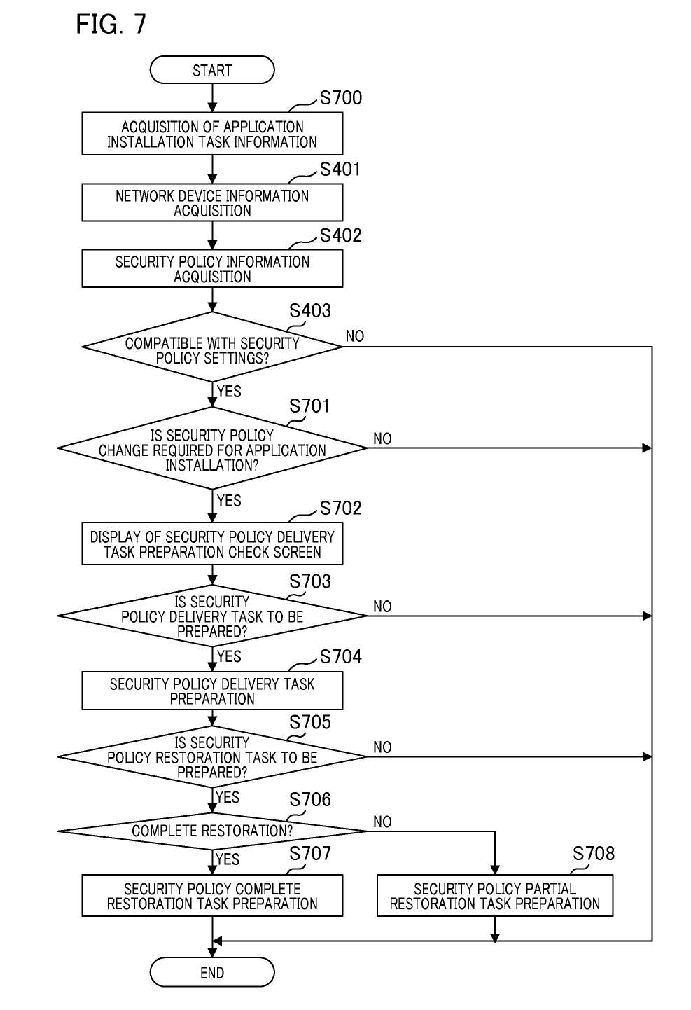

Using FIG. 7, a description is given below of operations of the application server 100 when the application server 100 dynamically delivers a security policy according to preparation conditions of a task that manages the MFP 150. As steps S400 to S403 are identical to the steps of FIG. 4 of the first embodiment, description thereof is omitted.

First, in step S700, the application management module 208 of the network device management application 202 acquires application installation task information from a table of the database server service module 210. The application installation task information is acquired from the application management table 304 and the application installation task management table 305 of the database server service module 210. When the application installation task information is acquired, the processing proceeds to step S401. Description of steps S401 and S402 is omitted.

When the security policy management module 205 determines in step S403 that the MFP 150 is compatible with the security policy settings (YES), the processing proceeds to step S701. In step S701, the security policy management module 205 determines whether or not a security policy change is required when the application is installed based on the application installation information. As a method for determining whether or not a security policy change is required, for example, it may be determined when the application vendor is a third party whether there is a setting that prohibits installation of third-party applications in the security policy settings. Apart from this, it may also be determined whether or not the network protocol/port required for installation of the application is usable with the security policy settings.

When it is determined that a security policy change is required when an application is installed (YES), the processing proceeds to step S702, and when it is determined that the security policy change is not required (NO), the processing is terminated as is. In step S702, the security policy management module 205 displays a screen that determines the preparation of a security policy delivery task via the UI module 202.

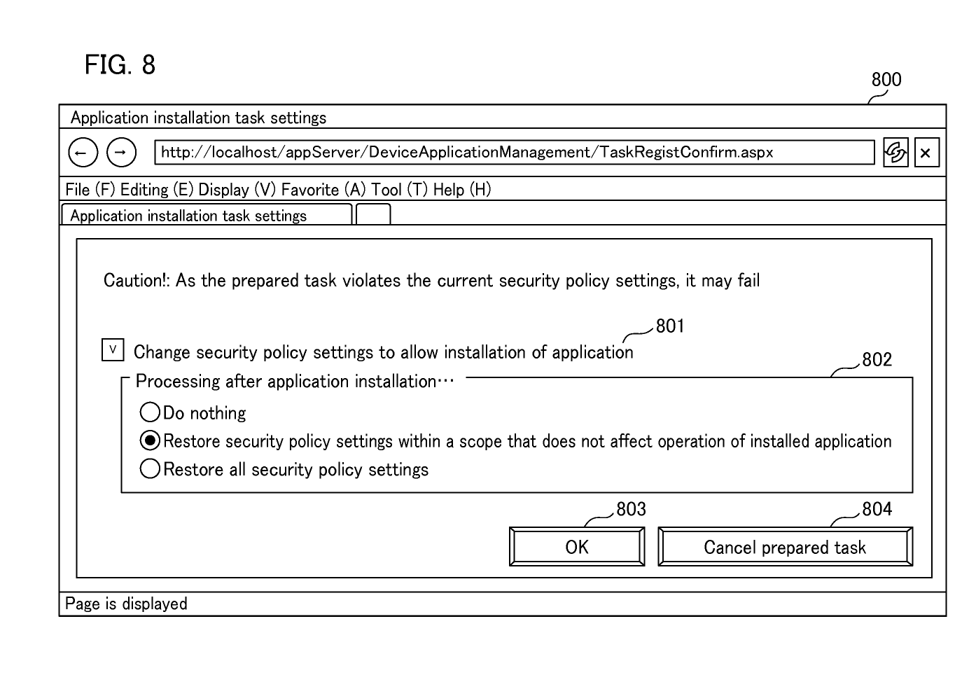

A screen example of a security policy delivery task preparation check screen is shown in FIG. 8. In a web browser screen 800, a security policy delivery task preparation validation check box 801 illustrates that security policy delivery task preparation is conducted prior to execution of an application installation task in a state where the checkbox is checked. After application delivery, a security policy restoration task preparation setting region 802 is a UI control that selects a processing content after execution of the application installation task. In FIG. 8, the setting of restoration processing is decided by selecting from the three items of “do nothing,” “restore security policy settings within a scope that does not affect operation of installed application,” and “restore all security policy settings.”

When an OK button 803 is clicked, the processing advances to step S703 in a state where the selection condition of the screen is stored in memory. When an application installation task cancellation button 804 is clicked, the application installation task is canceled, and processing terminates. The foregoing is a complete description of FIG. 8.

In step S703, the security policy management module 205 determines whether or not a security policy delivery task is prepared based on a user input result in the security policy delivery task preparation check screen. When it is determined that a security policy delivery task is prepared (YES), the processing advances to step S704, and when it is determined that it is not prepared (NO), the processing is terminated as is.

In step S704, the security policy management module 205 prepares a security policy delivery task to be executed prior to execution of an application installation task. In step S705, the security policy management module 205 determines whether or not a security policy restoration task is prepared based on a user input result in a security policy delivery task preparation check screen. When it is determined that a security policy restoration task is prepared (YES), the processing advances to step S706, and when it is determined that it is not prepared (NO), the processing is terminated as is.

In step S706, the security policy management module 205 determines whether the prepared security policy restoration task conducts complete restoration or partial restoration based on a user input result in the security policy delivery task preparation check screen. The complete restoration means that a security policy prior to change by a security policy delivery task is completely restored to the current security policy settings. In the screen example of FIG. 8, complete restoration is equivalent to the selection item of “restore all security policy settings” in the security policy restoration task preparation setting region 802.

The partial restoration means that a security policy changed by a security policy delivery task is restored to the current security policy settings within a scope that does not affect operation of the application that is installed by the application installation task. The partial restoration is equivalent to the selection item of “restore security policy settings within a scope that does not affect operation of installed application” in the security policy restoration task preparation setting region 802 in the screen example of FIG. 8. When it is determined that the acquired security policy restoration task is complete restoration (YES), the processing advances to step S707, and when it is determined that it is partial restoration (NO), the processing advances to step S708.

In step S707, the security policy management module 205 prepares a security policy complete restoration task based on the acquired security policy information. On the other hand, in step S708, the security policy management module 205 prepares a security policy partial restoration task based on the acquired security policy information and the application installation task information.

According to the above processing, a security policy can be dynamically changed according to preparation conditions of a task that manages the MFP 150. The present embodiment described an application installation task as exemplary of a task that manages the MFP 150, but it may also be applied to other management tasks.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-131046, filed on Jun. 21, 2013, which is hereby incorporated by reference herein in its entirety.

What is claimed is:

1. A network device management apparatus, comprising:
an acquisition unit configured to acquire management information that indicates a management condition of network device;
a decision unit configured to decide a security policy based on the management information; and
a delivery unit configured to deliver the security policy to the network device that is compatible with security policy settings.

2. The network device management apparatus according to claim 1, wherein the management information is setting information or history information of the network device.

3. The network device management apparatus according to claim 1, wherein the management information is information that indicates a time elapsed after start of management of the network device or a time elapsed until management of the network device ends.

4. The network device management apparatus according to claim 1, wherein the management information is information of a user who utilizes the network device.

5. The network device management apparatus according to claim 1, wherein, when settings according to the security policy delivered to the network device is required to change for delivering the application, the decision unit decides settings for processing that restores settings according to the security policy delivered to the network device after delivery of an application, and the delivery unit delivers the decided settings together with the security policy.

6. The network device management apparatus according to claim 5, wherein processing that restores settings according to the security policy is processing that restores settings according to the security policy prior to change within a scope that does not affect operation of the application.

7. The network device management apparatus according to claim 5, wherein processing that restores settings of the security policy is processing that restores all settings of the security policy prior to change.

8. The network device management apparatus according to claim 5, wherein processing that restores settings according to the security policy after installation of the application is performed in the network device.

9. A management method, comprising:
acquiring management information indicating management conditions of network device;
deciding a security policy based on the management information; and
delivering the security policy to the network device that is compatible with security policy settings.

10. A non-transitory storage medium storing a readable program for causing a computer to execute a management method, the method comprising:
acquiring management information indicating management conditions of network device;
deciding a security policy based on the management information; and
delivering the security policy to the network device that is compatible with security policy settings.
